(19) United States
(12) Patent Application Publication
(10) Pub. No.: US 2014/0117864 A1
(43) Pub. Date: May 1, 2014

(54) WHITE AC LED

(71) Applicant: Switch Bulb Company, Inc., San Jose, CA (US)

(72) Inventor: Ronald J. LENK, Woodstock, GA (US)

(73) Assignee: Switch Bulb Company, Inc., San Jose, CA (US)

(21) Appl. No.: 14/060,509

(22) Filed: Oct. 22, 2013

Related U.S. Application Data
(63) Continuation of application No. 13/062,207, filed on May 5, 2011, now Pat. No. 8,598,794.
(60) Provisional application No. 61/106,031, filed on Oct. 16, 2008.

(51) Int. Cl. H05B 33/08

(52) U.S. Cl. CPC H05B 33/0857
USPC 315/185 R

(57) ABSTRACT

A multi-color white LED which can be driven by a single current, and more particularly, to the use of a specific ratio of numbers of different color LEDs to obtain a specific desired color while running all of them at the same current.

### FIELD OF THE INVENTION

The present invention relates to multi-color white LEDs, which can be driven by a single current, and more particularly, to the use of a specific ratio of a plurality of LEDs having a different color spectrum to obtain a desired color and while running each of the LEDs at the same current.

### BACKGROUND OF THE INVENTION

Although most LEDs (light emitting diodes) today are devices which run at low voltage, the technology exists to run LEDs directly from a high voltage source, such as an AC (alternating current) line. Two common circuits for running LEDs directly from a high voltage source both place enough LEDs in a series string that their forward voltage at a desired current is approximately equal to that of the AC line voltage. In one circuit technique, two anti-parallel strings are placed directly across the AC line, with one string conducting during the first half line-cycle and the other during the second half. In a second circuit technique, a single string of LEDs is placed after a bridge rectifier, so that the single string of LEDs conducts during both halves of the line-cycle.

In both of these circuit techniques up until now, white LEDs have been created by using a string of white LED dice. It can be appreciated that this works well, if the dice are available to produce the exact shade of white, which is desired. However, in many cases the particular desired white is not available, in which case there is no way to use an AC LED, and designers must go to DC (direct current) LEDs and use complicated and expensive AC/DC converters to run them.

The other method of obtaining white light from LEDs is to use a combination of two or more different color LEDs. This is commonly done in DC LEDs. However, in circuits to date this has been impracticable in AC LEDs, because each LED color must be run at its own current. The reason for this is that to create white light requires a different amount of each LED color. Further, each LED color has different efficacy, the two factors together resulting in each LED color typically being run on its own converter.

Accordingly, it would be desirable to have the ability to select the precise shade of white delivered by an AC LED, which would permit more inexpensive LED lights to be produced for more applications. In addition, it would be desirable to generate arbitrary colored light using AC LEDs rather than needing one or more AC/DC converters.

### SUMMARY OF THE INVENTION

In accordance with an exemplary embodiment, one of the objects of this invention is developing a circuit with white or arbitrary light color output, and which provides an AC LED whose light color may be selected by the designer arbitrarily, without requiring one or more AC/DC converters. In accordance with an exemplary embodiment, the circuit includes a specific ratio of a plurality of different color LEDs, the ratio being based on the desired output light color and the efficacy of each color LED. In accordance with an embodiment, the total number of LEDs in the circuit is determined by the forward voltage required to obtain the desired average LED current, factoring in the difference in forward voltage of the different color LEDs. In addition, it can be appreciated that the same current can be run through each of the LEDs, permitting operation as a single string.

In accordance with one embodiment, three colors of LEDs are used, red, green and blue (RGB), and wherein the ratios of the numbers of LEDs of each of the three colors is selected to give the correct output light color, factoring in the efficacy of the individual color LEDs by considering their light output at the same current. In addition, the total number of LEDs is selected to give the appropriate forward voltage to be operated from the AC line, accounting for the differing forward voltage (or forward voltage drop) of each of the differing colors of LEDs.

In accordance with an exemplary embodiment, an LED includes at least two colors of LEDs, a ratio of the at least two colors of LEDs being selected to obtain a desired color spectrum, and wherein all of the at least two colors of LEDs are run in series at the same current. In accordance with another exemplary embodiment, an LED includes a plurality of different color LEDs, which are selected based on a desired output light color and an efficacy of each of the plurality of different color LEDs, and wherein the plurality of different color LEDs are all run in series at the same current.

In accordance with an exemplary embodiment, a method of producing a spectrum of white light from a plurality of color LEDs, includes the steps of selecting at least one LED from at least two colors of LEDs; establishing a ratio of the at least one LED from at least two colors of LEDs to obtain a desired color spectrum; and running the plurality of LEDs in series at a desired current. In accordance with another exemplary embodiment, a method of developing a circuit with white or arbitrary light color output, includes the steps of providing a plurality of color LEDs; establishing a ratio of the plurality of color LEDS based on the desired output light color and efficacy of the each of the selected color LEDs; and running the plurality of color LEDs in series at a desired current. In accordance with a further exemplary embodiment, a method of producing a spectrum of white light from a plurality of LEDs having a different color spectrum, includes the steps of selecting a plurality of LEDs having a different color spectrum; establishing a specific ratio of the plurality of LEDs having a different color spectrum to obtain a desired color; and running the plurality of LEDs having a different color spectrum in series at the same desired current.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a drawing of the spectrum of white light from an incandescent source.

FIG. 2 is a schematic of a circuit that uses a set of RGB (red, green, and blue) LEDs to produce a white AC LED.

FIG. 3 is a view of a device using RGB (red, green, and blue) LEDs to produce a white AC LED.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

According to the design characteristics, a detailed description of the current practice and preferred embodiments is given below.

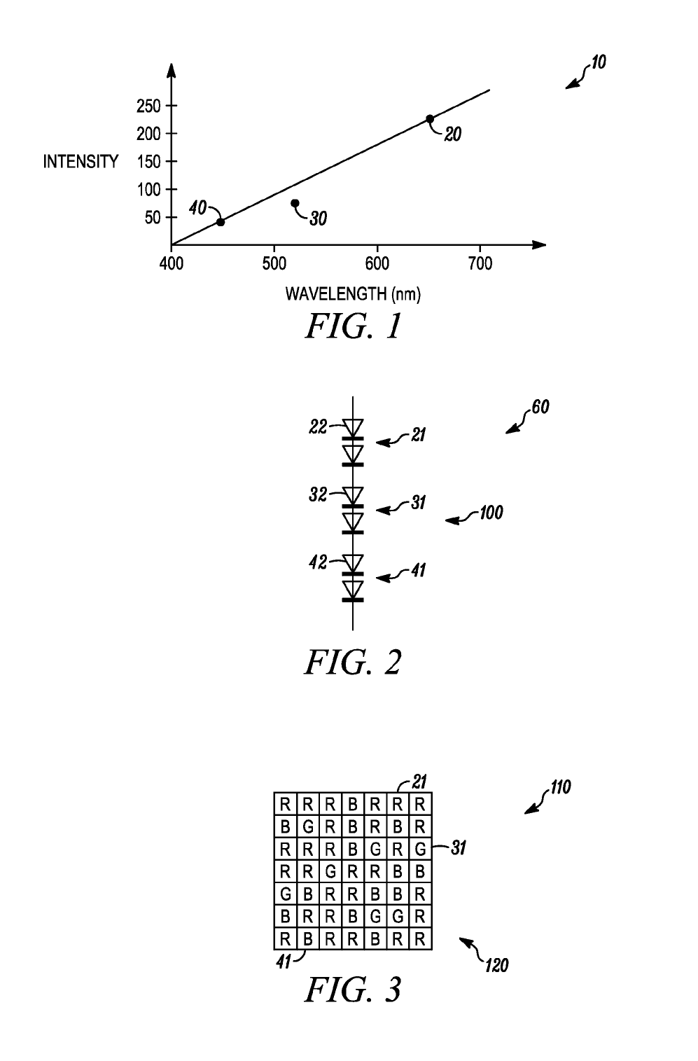

FIG. 1 is a drawing of a spectrum 10 of white light from an incandescent source. In this drawing, with arbitrary scale, red light 20 at 650 nm is approximately 230 units, green light 30 at 525 nm is approximately 75 units, and blue light 40 at 450 nm is approximately 45 units.

FIG. 2 is a schematic of an exemplary circuit 60 that uses a plurality of red LEDs 21, a plurality of green LEDs 31 and a plurality of blue LEDs 41 to produce a white AC LED 100. In accordance with an exemplary embodiment, a red LED 22 typically has a forward voltage (or forward voltage drop) of approximately 2.2V at a specified current, a green LED 32 typically has a forward voltage of approximately 3.4V at the same current, and a blue LED 42 typically has a forward voltage of approximately 3.4V at the same current. In accordance with this exemplary embodiment, a single red LED 22 has a luminous flux of approximately 40 in arbitrary units at this same current, a single green LED 32 has a luminous flux of 52 in the same units at this same current, and a single blue LED 42 has a luminous flux of 15 in the same units at this same current.

In accordance with this exemplary embodiment, the desired ratio of red to green to blue (i.e., R:G:B) LEDs 21, 31, 41 to obtain the spectrum 10 of white light from an incandescent source as shown in FIG. 1 is approximately equal to the following ratio: 230:75:45. In order to achieve this with luminous fluxes in the ratio R:G:B=40:52:15, the LED would have the number of LEDs in the ratio R:G:B equal to approximately (230/40):(75/52):(45/15)=5.75:1.44:3.00≈4:1:2.

In this exemplary embodiment, using 4 (four) red LEDs 21 plus 1 (one) green LED 31 plus 2 (two) blue LEDs 41 in series would produce a forward voltage of 4*2.2V+1*3.4V+2*3.4V=19V. However, in order to achieve a forward voltage of 120V, suitable for the AC line, the number of such sets of LEDs should be approximately 120V/19V≈6. Thus, this gives a total of 24 (twenty-four) red LEDs 21, 6 (six) green LEDs 31 and 12 (twelve) blue LEDs 41. By selecting 7 sets, the total number of LEDs 100 may be made equal to 49, a square number. 49 (forty-nine) LEDs 100 may be made suitable for the AC line by suitable adjustment of the operating current for the circuit. It can be appreciated that circuits 60 with more or less than three colors of LEDs 21, 31, 41 and more or less sets of LEDs can be implemented based on the desired color spectrum.

In addition, the exemplary embodiment as shown in FIG. 2, is only an exemplary embodiment, and that the at least two color LEDs are not limited to red, blue and green LEDs, such that the circuits and methods as described herein can be extended to any color LED or LED having a different color spectrum, and which is capable of producing a desired color spectrum in combination with at least one other color LED. In addition, the parameters for the color LEDs as they pertain to wavelength, forward voltage, and luminous fluxes are only examples, and should not be construed as limiting parameters for those color LEDs or other suitable color LEDs.

FIG. 3 is a view of a device using RGB LEDs to produce a white AC LED 110. In a preferred embodiment, 28 (twenty-eight) red LEDs 21, 7 (seven) green LEDs 31 and 14 blue LEDs 41, which are randomly arranged in a 7×7 die matrix 120. The random arrangement is selected in order to aid mixing of the colors of light. It can be appreciated that the red LEDs 21, green LEDs 31, and the blue LEDs 41 can be randomly arranged in any suitable matrix and is not limited to a 7×7 die matrix 120. For example, the die matrix 120 can be a 3×3, a 5×5, a 7×7, a 9×9, or larger, or can be non-square, for example 6×7.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

1. An LED light source comprising:
a first set of LEDs, the first set of LEDs comprising one or more LEDs of a first color;
a second set of LEDs, the second set of LEDs comprising one or more LEDs of a second color, wherein the first color and the second color are different;
a third set of LEDs, the third set of LEDs comprising one or more LEDs of a third color, wherein the first color and the third color are different, and wherein the second color and the third color are different;
wherein a ratio of the number of LEDs in the first set of LEDs to the number of LEDs in the second set of LEDs is 1 to 2, and
wherein a ratio of the number of LEDs in the first set of LEDs to the number of LEDs in the third set of LEDs is 2 to 1; and
wherein the LEDs in the first set of LEDs, the second set of LEDs, and the third set of LEDs are in series.

2. An LED light source as set forth in claim 1, wherein the number of LEDs in the first set, the second set, and the third set are selected to produce a desired forward voltage.

3. An LED light source as set forth in claim 2, wherein the desired forward voltage is an AC line voltage.

4. An LED light source as set forth in claim 1, wherein the first color, the second color, and the third color are selected from the group consisting of red, green and blue.

5. An LED light source as set forth in claim 1, wherein the LEDs in the first set have a wavelength between approximately 430 nm and 480 nm, wherein the LEDs in the second set have a wavelength between approximately 600 and 630 nm, and wherein the LED light source includes a group of luminophores which are configured to emit light of a wavelength between approximately 555 nm and 585 nm.

6. An LED light source as set forth in claim 1, wherein the LED light source is configured to achieve a desired color spectrum of white.

7. An LED light source as set forth in claim 1, wherein the LEDs in the first set, the second set, and the third set of LEDs are arranged in a matrix.

8. An LED light source as set forth in claim 7, wherein the LEDs in the first set, the second set, and the third set of LEDs are randomly arranged in the matrix.

9-17. (canceled)

18. A method of producing a spectrum of white light or arbitrary light color from a plurality of LEDs, comprising:
selecting a first set of LEDs, the first set of LEDs comprising one or more LEDs of a first color;
selecting a second set of LEDs, the second set of LEDs comprising one or more LEDs of a second color, wherein the first color and the second color are different;
selecting a third set of LEDs, the third set of LEDs comprising one or more LEDs of a third color, wherein the first color and the third color are different, and wherein the second color and the third color are different;
determining the number of LEDs in the first set and the number of LEDs in the second set based on a ratio of 1 LED of the first color to 2 LEDs of the second color, and
determining the number of LEDs in the first set and the number of LEDs in the third set based on a ratio 2 LEDs of the first color to 1 LED of the third color to obtain a desired color spectrum; and
configuring the LEDs in the first set, second set, and third set of LEDs in series.

19. A method as set forth in claim 18, wherein the numbers of LEDs in the first set, the second set, and the third set of LEDs are selected to produce a desired forward voltage.

20. A method as set forth in claim 19, wherein the desired forward voltage is an AC line voltage.

21. A method as set forth in claim 18, wherein the first color, the second color, and the third color are selected from the group consisting of red, green and blue.

22. A method as set forth in claim 18, the method further comprising:
selecting a group of luminophores which are configured to emit light of a wavelength of between approximately 555 nm and 585 nm,
wherein the LEDs in the first set have a wavelength between approximately 430 nm and 480 nm, and
wherein the LEDs in the second set have a wavelength between approximately 600 nm and 630 nm.

23. A method as set forth in claim 18, wherein the desired color spectrum is white.

24. A method as set forth in claim 18, the method further comprising arranging the LEDs in the first set, the second set, and the third set of LEDs in a matrix.

25. A method as set forth in claim 24, the method further comprising randomly arranging the LEDs in the first set, the second set, and the third set of LEDs in the matrix.

26-32. (canceled)
